(19) United States
(12) Patent Application Publication
(10) Pub. No.: US 2006/0012244 A1
(43) Pub. Date: Jan. 19, 2006

(54) Electromagnetic Car

(76) Inventor: Qin Chao Tan, Brooklyn, NY (US)

Correspondence Address: QIN CHAO TAN, 2248 84TH STREET, BROOKLYN, NY, 11214, US

(21) Appl. No.: 10/710,468

(22) Filed: Jul. 13, 2004

(51) Int. Cl. B60T 8/64

(52) U.S. Cl. 303/152

(57) ABSTRACT

The purpose of this invention is to make the car run faster and farther than other electric cars already invented.

### DETAILED DESCRIPTION

Use the belt to assist the automatic-cycling component parts (car axle and car wheel) of a car in as an impetus for the electromagnet. Or apply a chain wheel (similar to the installment of a bicycle). Then attach a drive chain to the chain wheel along with the electromagnet (the amount attached can vary depending on your needs).

Apply an electromagnetic within a vacuum. We placed a multi-angular magnet, surrounded by two wires (one for the battery, and the other for the accelerator), in a vacuum. To prevent overheating of the model, a cooling system consisting of a pipe can be inserted, touching the wires so the heat can be transferred.

1. When the car is at high speeds:

2. Use the accelerator and cut the electricity flowing from the battery and connect it to the electromagnet.

3. link the electromagnet to the battery.

4. You can add one more battery to a car for preparatory use. When one battery becomes empty, the second one would be activated in order to run the car. Then use the electromagnet to recharge the empty battery.

5. All Claims list above from [c1] to [c4] are apply for [0001]
